(19) United States
(12) Patent Application Publication
(10) Pub. No.: US 2026/0054467 A1
(43) Pub. Date: Feb. 26, 2026

(54) META-SHEET CAPABLE OF INDEPENDENT DESIGN OF POISSON'S RATIO AND COEFFICIENT OF THERMAL EXPANSION, AND METHOD OF DESIGNING THE SAME

(71) Applicant: SEOUL NATIONAL UNIVERSITY R&DB FOUNDATION, Seoul (KR)

(72) Inventors: Do-Nyun Kim, Seoul (KR); Duhwan Kang, Seoul (KR)

(21) Appl. No.: 19/059,582

(22) Filed: Feb. 21, 2025

(30) Foreign Application Priority Data
Aug. 21, 2024 (KR) 10-2024-0111930

(51) Int. Cl. B32B 7/027; B32B 3/18

(52) U.S. Cl. CPC B32B 7/027; B32B 3/18; B32B 2307/30; B32B 2307/706

(57) ABSTRACT

Disclosed are a meta-sheet capable of independent design of a Poisson's ratio and a coefficient of thermal expansion, and a method of designing the same, the meta-sheet including: unit structures shaped like polygons, formed of beams, and arranged continuously with polygonal edges connected by hinges so that the meta-sheet can expand or contract at a predetermined Poisson's ratio as the unit structures are rotated by external force, wherein the beam is formed as a bilayer beam into which two materials different in the coefficient of thermal expansion are jointed in a longitudinal direction, and bending deformation occurs due to heat so that the meta-sheet can expand or contract by external heat.

### CROSS-REFERENCE TO RELATED APPLICATION

This application claims priority from Korean Patent Application No. 10-2024-0111930, filed on Aug. 21, 2024 in the Korean Intellectual Property Office, the disclosure of which is incorporated herein by reference.

### BACKGROUND OF THE INVENTION

### (a) Field of the Invention

The disclosure relates to a meta-sheet capable of independent design of a Poisson's ratio and a coefficient of thermal expansion and a method of designing the same, and more particularly to a meta-sheet capable of independent design of a Poisson's ratio (PR) and a coefficient of thermal expansion (CTE), which expands or contracts with a mechanical load (external force) or thermal load applied thereto, and is manufactured by controlling a Poisson's ratio (PR) due to the mechanical load and a coefficient of thermal expansion (CTE) due to the thermal load independently of each other, and a method of designing the same.

### (b) Description of the Related Art

A Poisson's ratio (PR) and a coefficient of thermal expansion (CTE) are physical properties involved in a stress-strain relationship when a mechanical load (external force) and a thermal load are applied, respectively.

FIG. 1 is a diagram explaining the Poisson's ratio and the coefficient of thermal expansion.

The Poisson's ratio refers to a rate of expansion or contraction transverse to axial strain. When compressive force is applied in a y-axial direction, the Poisson's ratio generally has a positive value based on expansion in an x-axial direction as shown on the left in (a) of FIG. 1. However, when the compressive force is applied in the y-axial direction, a structural design such as an auxetic structure may cause the Poisson's ratio to have a negative value based on contraction in the x-axial direction as shown on the right in (a) of FIG. 1.

As shown in (b) of FIG. 1, the coefficient of thermal expansion is defined as a rate of thermal expansion of an object depending on temperature under constant pressure.

In conventional structures capable of simultaneously controlling the Poisson's ratio and the coefficient of thermal expansion, it is not easy to design a structure having a desired Poisson's ratio and a desired coefficient of thermal expansion because a mechanism for controlling the Poisson's ratio and a mechanism for controlling the coefficient of thermal expansion are identical or coupled to each other, and a range of use is limited because a designable area is narrow.

Accordingly, the disclosure proposes a meta-sheet, of which the Poisson's ratio and the coefficient of thermal expansion are independently controllable and designable, and a method of designing the same.

### Document of Related Art

### Patent Document

Korean Patent Publication No. 10-2024-0080775

### SUMMARY OF THE INVENTION

Accordingly, the disclosure has been conceived to solve the foregoing problems, and an aspect of the disclosure is to provide a meta-sheet capable of independent design of a Poisson's ratio and a coefficient of thermal expansion, the meta-sheet including unit structures shaped like polygons, formed of beams, and arranged continuously with polygonal edges connected by hinges so that the meta-sheet can expand or contract at a predetermined Poisson's ratio by external force, wherein the beam is formed as a bilayer beam into which two materials different in the coefficient of thermal expansion are jointed in a longitudinal direction, and bending deformation occurs due to heat so that the meta-sheet can expand or contract by external heat, and the Poisson's ratio and the coefficient of thermal expansion are independently designable by adjusting the thickness of the hinge and the thickness of the bilayer beam.

The problems to be solved by the disclosure are not limited to those mentioned above, and other unmentioned problems will become apparent to a person skilled in the art by the following descriptions.

In accordance with an embodiment of the disclosure, there is provided a meta-sheet capable of independent design of a Poisson's ratio and a coefficient of thermal expansion, the meta-sheet including unit structures shaped like polygons, formed of beams, and arranged continuously with polygonal edges connected by hinges so that the meta-sheet can expand or contract at a predetermined Poisson's ratio as the unit structures are rotated by external force, wherein the beam is formed as a bilayer beam into which two materials different in the coefficient of thermal expansion are jointed in a longitudinal direction, and bending deformation occurs due to heat so that the meta-sheet can expand or contract by external heat.

Here, the polygon may include any one of a square, a rectangle, and a parallelogram.

Here, the Poisson's ratio is controlled by adjusting the thickness of the hinge.

Here, the coefficient of thermal expansion of the meta-sheet is controlled by adjusting the thickness of the bilayer beam.

Here, the bilayer beam includes two different materials are arranged alternately in the longitudinal direction.

In accordance with an embodiment of the disclosure, there is provided a method of designing a meta-sheet capable of independent design of a Poisson's ratio and a coefficient of thermal expansion, the method including: setting a target size of the meta-sheet, a target Poisson's ratio of the meta-sheet, and a target coefficient of thermal expansion of the meta-sheet for the meta-sheet having the foregoing structure; creating an initial design of the meta-sheet by setting a shape of the unit structure and a connection angle between the unit structures based on the target Poisson's ratio and the target coefficient of thermal expansion; obtaining the Poisson's ratio and the coefficient of thermal expansion for the meta-sheet of the initial design through a structural simulation program; and adjusting the thickness of the hinge or the thickness of the bilayer beam to obtain a thickness value of the hinge and a thickness value of the bilayer beam to reach the target Poisson's ratio and the target coefficient of thermal expansion.

Here, the thickness of an initial hinge is set to be smaller than the thickness of an initial bilayer beam.

The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a diagram explaining a Poisson's ratio and a coefficient of thermal expansion.

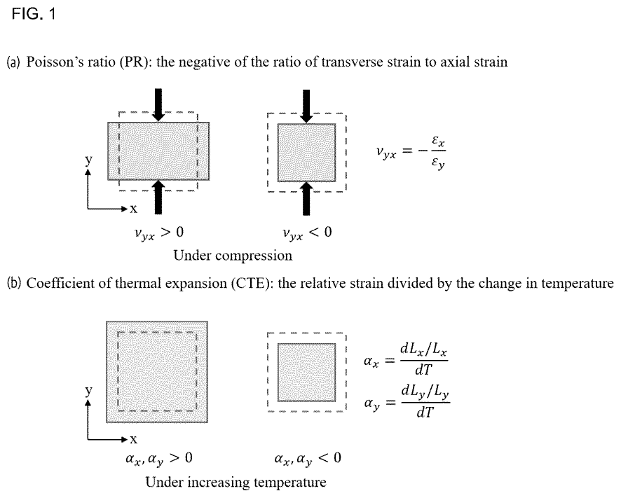

FIG. 2 shows a meta-sheet capable of independent design of a Poisson's ratio and a coefficient of thermal expansion according to an embodiment of the disclosure.

FIG. 3 is a diagram showing shrinkage deformation due to axial compression in FIG. 2.

FIG. 4 is a diagram showing shrinkage deformation due to thermal stress in FIG. 2.

FIG. 5 shows experimental results showing that the Poisson's ratio of a meta-sheet according to the disclosure is independently controllable without affecting the coefficient of thermal expansion depending on the thickness h of a hinge.

FIG. 6 shows experimental results showing that the coefficient of thermal expansion of a meta-sheet according to the disclosure is independently controllable without affecting the Poisson's ratio depending on the thickness H of a bilayer beam.

FIG. 7 shows experimental results of design change in a meta-sheet according to the disclosure.

FIG. 8 shows experimental results that a meta-sheet according to the disclosure can have a coefficient of anisotropic thermal expansion.

FIG. 9 is a diagram showing a method of designing a meta-sheet capable of independent design of a Poisson's ratio and a coefficient of thermal expansion according to an embodiment of the disclosure.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION

Specific features of embodiments are involved in the detailed description and the accompanying drawings.

The merits and features of the disclosure, and methods of achieving them will become apparent with reference to the embodiments described below in detail and the accompanying drawings. However, the disclosure is not limited to the embodiments set forth herein, but may be implemented in various forms. The following embodiments are provided in order to fully describe the disclosure and enable those skilled in the art, to which the disclosure pertains, to understand the disclosure, the scope of which is defined in the appended claims. Like numerals refer to like elements throughout.

Below, a meta-sheet capable of independent design of a Poisson's ratio and a coefficient of thermal expansion and a method of designing the same according to embodiments of the disclosure will be described with reference to the accompanying drawings.

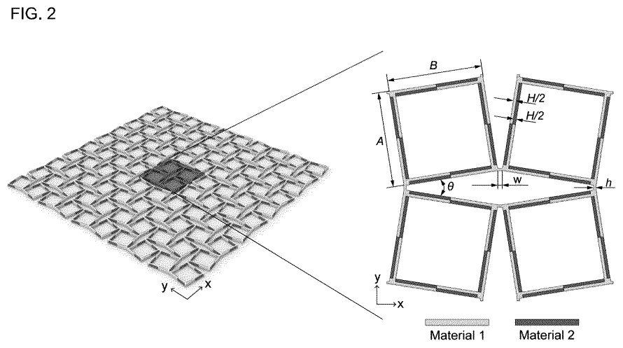

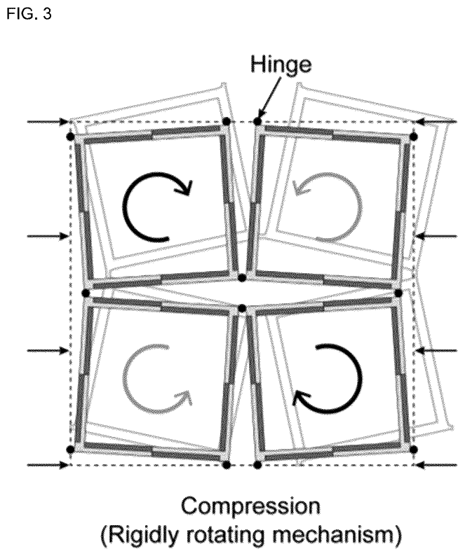

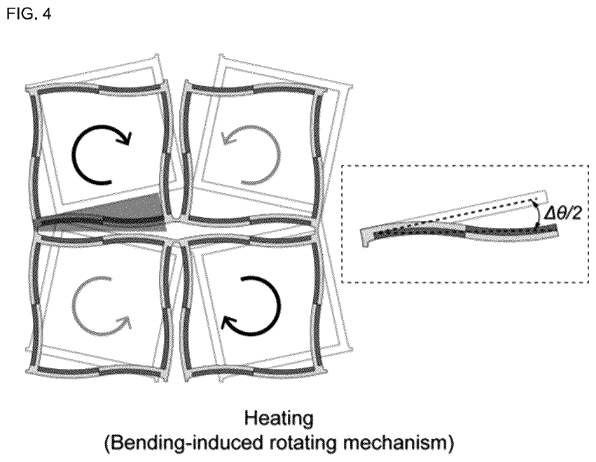

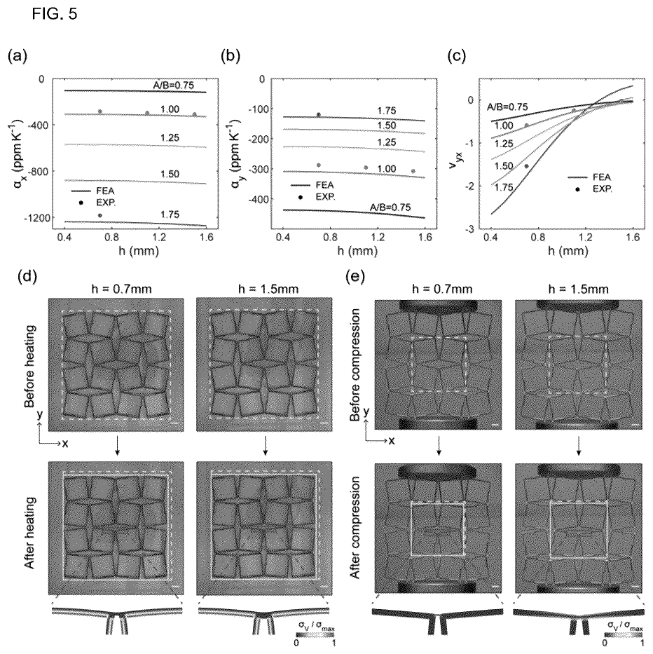

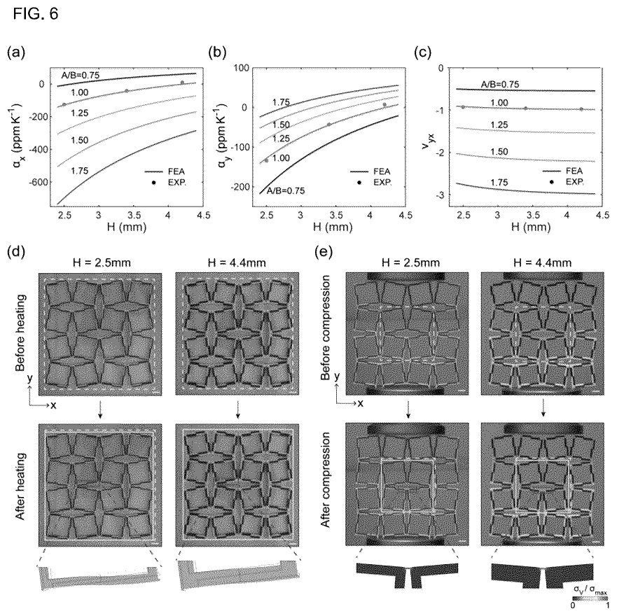

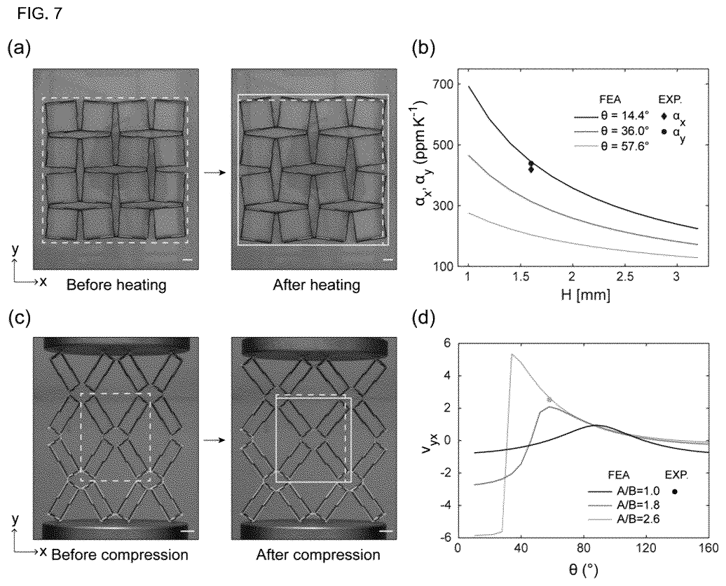

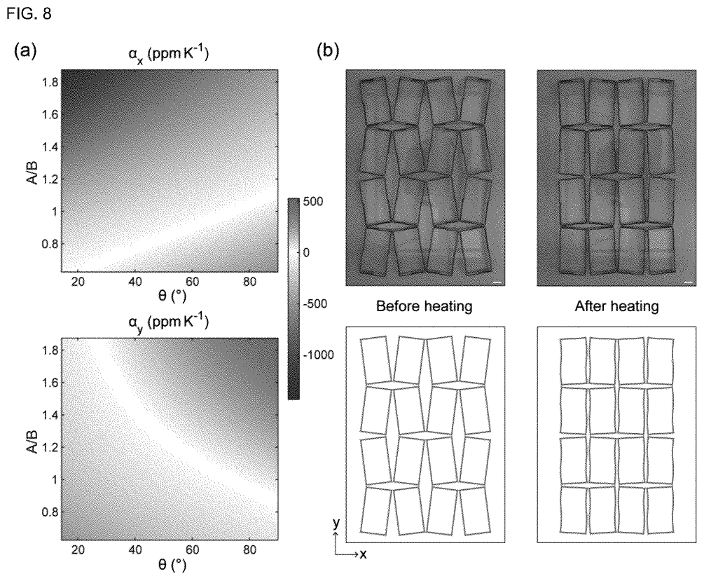

FIG. 2 shows a meta-sheet capable of independent design of a Poisson's ratio and a coefficient of thermal expansion according to an embodiment of the disclosure, FIG. 3 is a diagram showing shrinkage deformation due to axial compression in FIG. 2, FIG. 4 is a diagram showing shrinkage deformation due to thermal stress in FIG. 2, FIG. 5 shows experimental results showing that the Poisson's ratio of a meta-sheet according to the disclosure is independently controllable without affecting the coefficient of thermal expansion depending on the thickness h of a hinge, FIG. 6 shows experimental results showing that the coefficient of thermal expansion of a meta-sheet according to the disclosure is independently controllable without affecting the Poisson's ratio depending on the thickness H of a bilayer beam, FIG. 7 shows experimental results of design change in a meta-sheet according to the disclosure, and FIG. 8 shows experimental results that a meta-sheet according to the disclosure can have a coefficient of anisotropic thermal expansion.

As shown therein, the meta-sheet capable of independent design of the Poisson's ratio (PR) and the coefficient of thermal expansion (CTE) according to an embodiment of the disclosure (hereinafter referred to as the “meta-sheet”) includes polygonal unit structures arranged continuously, in which polygonal edges are connected to the neighboring unit structures by hinges.

According to the disclosure, the hinge connection may refer to that two edges are connected with a material having a certain thickness h and a certain width w as shown. Further, a hinge portion may be formed by extending and connecting any one material that forms a bilayer beam (to be described later), or may be formed of an independent material.

In this case, the unit structure may be shaped like a square as shown, or may be shaped like a rectangle or parallelogram, of which a length A and a width B are different from each other. Further, the shape of the unit structure is not limited to the square but may be a triangle or other polygons.

When compressive force is applied in an x-axial direction in an initial state where an angle between the neighboring unit structures is set to O as shown in FIG. 2, the hinge portion of connecting the unit structures serves as a hinge so that the unit structures can rotate and thus contract in a y-axial direction as shown in FIG. 3. In other words, the shown structure may have a negative Poisson's ratio. In this case, when the shape, initial connection angle θ, etc. of the unit structures are appropriately selected, a meta-sheet may be formed to have a positive Poisson's ratio.

In this case, according to the disclosure, the beam for forming the unit structure may be provided as a bilayer beam into which two materials (a first material and a second material) different in the coefficient of thermal expansion are joined in a longitudinal direction. Therefore, when the bilayer beam undergoes temperature change, bending deformation occurs as shown in a dotted box of FIG. 4 due to difference in the coefficient of thermal expansion between the two materials. In this case, according to this embodiment, the two materials of the bilayer beam may also be alternately arranged in the longitudinal direction. In other words, when the bilayer beam is divided into equal parts in the longitudinal direction, the positions of the first material and the second material are reversed in the divided areas. Because the first material according to this embodiment has a larger coefficient of thermal expansion, the divided left area of the bilayer beam bends convexly upward as the temperature increases, and the divided right area of the bilayer beam bends concavely downward as the temperature increases.

The bilayer beam may be manufactured by 3D-printing two materials with different coefficients of thermal expansion, but may can also be manufactured through a semiconductor process.

As temperature increases, the bilayer beams respectively forming the sides of the unit structure undergo the bending deformation at the same time, thereby rotating the unit structure. According to the disclosure, the meta-sheet may contract or expand in the x- and y-axial directions as temperature increases. FIG. 4 shows an example that the meta-sheet contracts, but the meta-sheet may be structured to expand with heating by appropriately designing the bending direction of the bilayer beam, the shape of the unit structure, and the initial connection angle θ. Further, as will be described below, the meta-sheet may also be designed to have anisotropic characteristics with different thermal expansion in the x- and y-axial directions as temperature increases. For example, the meta-sheet may contract in the x-axial direction but expand in the y-axial direction as temperature increases.

In this way, the meta-sheet according to the disclosure may contract or expand due to mechanical and thermal loads. In particular, the meta-sheet may be designed to have a negative Poisson's ratio or a positive Poisson's ratio, and may expand or contract isotropically or anisotropically by heating.

Because a deformation mechanism due to the mechanical load is based on the rotation of the hinge and a deformation mechanism due to thermal load is based on the rotation of the bilayer beam, the deformation mechanism due to mechanical load and the deformation mechanism due to thermal load are separated. Accordingly, by appropriately adjusting the variables affecting each mechanism, the Poisson's ratio of the meta-sheet and the coefficient of thermal expansion of the meta-sheet may be independently controlled to design the meta-sheet. In other words, only the Poisson's ratio of the meta-sheet may be controlled while the coefficient of thermal expansion of the meta-sheet is fixed, or only the coefficient of thermal expansion may be controlled while the Poisson's ratio of the meta-sheet is fixed.

Referring to FIG. 5, according to the disclosure, the meta-sheet having a predetermined shape (with different A/B) was manufactured with different thickness h of the hinge, and the deformation of the meta-sheet due to heat was measured as shown in (d) of FIG. 5 or the deformation of the meta-sheet due to external force was measured by applying compressive force in the y-axial direction as shown in (e) of FIG. 5. In FIG. 5, (a) and (b) show the results of deformation due to heat, in which there is little change in the coefficient of thermal expansion of the meta-sheet depending on the thickness of the hinge. Further, in FIG. 5, (c) shows the results of deformation due to the compressive force, in which the Poisson's ratio is varied depending on the thickness of the hinge.

Accordingly, to adjust only the Poisson's ratio of the meta-sheet while the coefficient of thermal expansion of the meta-sheet is fixed, the thickness h of the hinge may be changed. Because the thickness of the hinge does not affect the deformation mechanism due to the thermal load based on the bending of the bilayer beam, the coefficient of thermal expansion of the meta-sheet is not changed even though the thickness of the hinge is changed.

When the hinge is thin, the unit structure acts as a rigid body, and thus deformation mainly occurs only in a hinge portion by compressive force. As the hinge becomes thicker, the sides forming the unit structure are also deformed, and thus the Poisson's ratio is varied depending on change in the thickness of the hinge.

Referring to FIG. 6, according to the disclosure, the meta-sheet having a predetermined shape (with different A/B) was manufactured with different thickness H of the bilayer beam, and the deformation of the meta-sheet due to heat was measured as shown in (d) of FIG. 6 or the deformation of the meta-sheet due to external force was measured by applying compressive force in the y-axial direction as shown in (e) of FIG. 6. In FIG. 6, (a) and (b) show the results of deformation due to heat, in which a deformation rate of the meta-sheet is varied depending on the thickness of the bilayer beam. Further, in FIG. 6, (c) shows the results of deformation due to the compressive force, in which there is little change in the Poisson's ratio of the meta-sheet depending on the thickness of the bilayer beam.

Accordingly, to adjust only the coefficient of thermal expansion of the meta-sheet while the Poisson's ratio of the meta-sheet is fixed, the thickness H of the bilayer beam may be changed. Preferably, the thickness H of the bilayer beam may be adjusted in the state that the thickness H of the bilayer beam is sufficiently thicker than the thickness h of the hinge. When the thickness H of the bilayer beam changes, a bending degree of the bilayer beam changes, and thus a rotating amount of the unit structure changes, thereby allowing the coefficient of thermal expansion of the meta-sheet to be adjustable. Under the conditions that the thickness H of the bilayer beam is sufficiently thick, deformation occurs mainly in the hinge, and thus the Poisson's ratio can remain almost constant even though the thickness H changes.

In FIG. 7, (a) and (b) show the results of testing the coefficient of thermal expansion of the meta-sheets different in the initial connection angle O between the unit structures and the thickness H of the bilayer beam when the positions of the first material and the second material are swapped. By reversing the positions of the two materials that make up the bilayer beam, a bending direction is reversed according to temperature. It is shown that the meta-sheet is thermally expanded based on the changed bending direction of the bilayer beam due to temperature rise, and it is shown that a range of change in the coefficient of thermal expansion of the meta-sheet based on the thickness of the bilayer beam is varied depending on the initial connection angle between the unit structures. Further, it is shown that the coefficient of thermal expansion of the meta-sheet decreases as the thickness of the bilayer beam increases.

In FIG. 7, (c) and (d) show the results of testing the Poisson's ratio of the meta-sheet according to the shape (A/B) of the unit structure and the initial connection angle θ between the unit structures. It is shown that the Poisson's ratio of the meta-sheet varies depending on the shapes of the unit structure and the initial connection angles between the unit structures. Further, it is shown that the meta-sheet is manufactured to have a negative or positive Poisson's ratio according to the shapes of the unit structure and the initial connection angles between the unit structures.

FIG. 8 shows that the coefficient of thermal expansion in the x-axial direction and the coefficient of thermal expansion in the y-axial direction are differently adjustable anisotropically based on the initial design of the meta-sheet according to the disclosure. In (a) of FIG. 8, the upper graph shows the coefficient of thermal expansion in the x-axial direction according to the shapes (A/B) of the unit structure and the initial connection angles θ between the unit structures, and the lower graph shows the coefficient in the y-axial direction. For example, when A/B=1.8 and θ is 80 degrees, the coefficient of thermal expansion in the x-axial direction is negative (blue) and the coefficient of thermal expansion in the y-axial direction is positive (red). When A/B=0.8 and θ is 80 degrees, the coefficient of thermal expansion in the x-axial direction is positive (red) and the coefficient of thermal expansion in the y-axial direction is negative (blue). In other words, FIG. 8 shows the characteristics of the coefficient of anisotropic thermal expansion. Therefore, the disclosure provides the meta-sheet of which the coefficients of thermal expansion in the x- and y-axial directions are variously adjustable to be different from each other by appropriately controlling the shape (A/B) of the unit structure and the initial connection angle O between the unit structures.

Below, a method of designing the meta-sheet capable of the independent design of the Poisson's ratio and the coefficient of thermal expansion according to the disclosure will be described.

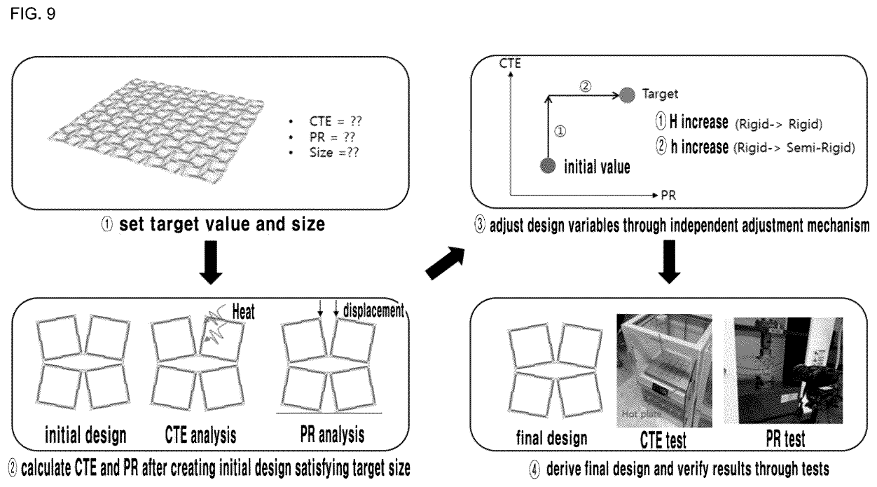

FIG. 9 is a diagram showing a method of designing a meta-sheet capable of independent design of a Poisson's ratio and a coefficient of thermal expansion according to an embodiment of the disclosure.

By the method of designing the meta-sheet according to the disclosure, the Poisson's ratio and coefficient of thermal expansion of the meta-sheet are calculated through the structural mechanical analysis of the meta-sheet depending on design variables, and the final design is derived through a mechanism of independently adjusting the Poisson's ratio and the coefficient of thermal expansion.

First, as shown in of FIG. 9, the size of the meta-sheet, the target Poisson's ratio (PR) of the meta-sheet, and the target coefficient of thermal expansion (CTE) of the meta-sheet are set for the meta-sheet having the foregoing structure.

Next, as shown in of FIG. 9, the initial design of the meta-sheet is created by setting the shape of the unit structure and the connection angle between the unit structures based on the target Poisson's ratio and the target coefficient of thermal expansion. As described above, the characteristics of the coefficient of thermal expansion may vary with a negative Poisson's ratio or a positive Poisson's ratio depending on the shape of the unit structure and the connection angle between the unit structures. Accordingly, the initial design may be created by setting the shape of the unit structure and the connection angle between the unit structures based on the target Poisson's ratio and the target coefficient of thermal expansion. In this case, it is preferable that the thickness of the hinge is sufficiently smaller than the thickness of the bilayer beam.

Next, the Poisson's ratio and the coefficient of thermal expansion are obtained through a structural simulation program for the initial design created according to the target Poisson's ratio and the target coefficient of thermal expansion. Through the known mechanical simulation program, the Poisson's ratio may be obtained based on the amount of deformation generated by applying external force to the initial design structure, and the coefficient of thermal expansion may be obtained based on the amount of deformation generated by applying heat to the initial design structure.

Next, as shown in of FIG. 9, the Poisson's ratio value and coefficient of thermal expansion value of the initial design are compared with the target Poisson's ratio value and the target coefficient of thermal expansion, and the foregoing independent adjustment mechanism is used to adjust the design variables. As described above, the design variables may include the thickness h of the hinge and the thickness H of the bilayer beam.

For example, as shown therein, the coefficient of thermal expansion is adjusted by increasing the thickness H of the bilayer beam while the Poisson's ratio is fixed, and then the Poisson's ratio is adjusted by adjusting the thickness h of the hinge while the coefficient of thermal expansion is fixed, thereby reaching the target values.

In this way, the final design of the meta-sheet is completed through the structural simulation program, and then the meta-sheet is manufactured based on the final design, thereby verifying the simulation results through actual tests.

As described above, with the meta-sheet capable of the independent design of the Poisson's ratio and the coefficient of thermal expansion according to the disclosure, and the method of designing the meta-sheet, there is an advantage of manufacturing the meta-sheet, which expands or contracts according to a mechanical load or thermal load, by independently controlling the Poisson's ratio according to the mechanical load and the coefficient of thermal expansion according to the thermal load.

Further, there is an advantage of manufacturing the meta-sheet having not only a negative Poisson's ratio but also a positive Poisson's ratio, the meta-sheet having a coefficient of isotropic thermal expansion, and the meta-sheet having a coefficient of anisotropic thermal expansion. In other words, there is an advantage that a range of use is wide due to a wide designable area.

The effects of the disclosure are not limited to the foregoing effects, but include all effects inferable from the detailed description or appended claims.

Although embodiments of the disclosure have been described above with reference to the accompanying drawings, a person having ordinary knowledge in the art to which the disclosure pertains will understand that the disclosure can be implemented in other specific forms without changing its technical idea or essential features. Therefore, the embodiments described above should be understood in all respects as illustrative rather than restrictive.

What is claimed is:

1. A meta-sheet capable of independent design of a Poisson's ratio and a coefficient of thermal expansion, the meta-sheet comprising:
unit structures shaped like polygons, formed of beams, and arranged continuously with polygonal edges connected by hinges so that the meta-sheet can expand or contract at a predetermined Poisson's ratio as the unit structures are rotated by external force, wherein
the beam is formed as a bilayer beam into which two materials different in the coefficient of thermal expansion are jointed in a longitudinal direction, and bending deformation occurs due to heat so that the meta-sheet can expand or contract by external heat.

2. The meta-sheet of claim 1, wherein the polygon comprises any one of a square, a rectangle, and a parallelogram.

3. The meta-sheet of claim 1, wherein the Poisson's ratio is controlled by adjusting a thickness of the hinge.

4. The meta-sheet of claim 1, wherein the coefficient of thermal expansion of the meta-sheet is controlled by adjusting a thickness of the bilayer beam.

5. The meta-sheet of claim 1, wherein the bilayer beam comprises two different materials are arranged alternately in the longitudinal direction.

6. A method of designing a meta-sheet capable of independent design of a Poisson's ratio and a coefficient of thermal expansion, the method comprising:
setting a target size of the meta-sheet, a target Poisson's ratio of the meta-sheet, and a target coefficient of thermal expansion of the meta-sheet for the meta-sheet of claim 1;
creating an initial design of the meta-sheet by setting a shape of the unit structure and a connection angle between the unit structures based on the target Poisson's ratio and the target coefficient of thermal expansion;
obtaining the Poisson's ratio and the coefficient of thermal expansion for the meta-sheet of the initial design through a structural simulation program; and
adjusting a thickness of the hinge or a thickness of the bilayer beam to obtain a thickness value of the hinge and a thickness value of the bilayer beam to reach the target Poisson's ratio and the target coefficient of thermal expansion.

7. The method of claim 6, wherein the thickness of an initial hinge is set to be smaller than the thickness of an initial bilayer beam.
